(19) United States
(12) Patent Application Publication
(10) Pub. No.: US 2008/0111335 A1
(43) Pub. Date: May 15, 2008

(54) STABILIZER BAR WITH A LATERAL RETENTION COLLAR AND METHOD OF MANUFACTURE

(75) Inventor: Jerry DiNello, Troy, MI (US)

Correspondence Address: GIFFORD, KRASS, SPRINKLE,ANDERSON & CITKOWSKI, P.C, PO BOX 7021, TROY, MI, 48007-7021, US

(73) Assignee: ThyssenKrupp Bilstein of America, Troy, MI (US)

(21) Appl. No.: 11/939,340

(22) Filed: Nov. 13, 2007

Related U.S. Application Data
(60) Provisional application No. 60/865,511, filed on Nov. 13, 2006.

(51) Int. Cl. B60G 21/055; B22D 19/04

(52) U.S. Cl. 280/124.106; 164/112; 164/75

(57) ABSTRACT

A stabilizer bar with a lateral retention collar is provided. The lateral retention collar is cast onto the stabilizer bar and can be made from a zinc-aluminum alloy. In addition, the lateral retention collar is cast onto the stabilizer bar using a die casting machine. The lateral retention collar has an axial sleeve with a flange that extends radially therefrom. In some instances, the flange has a width in the axial direction, with the width being between 5 and 50% of an overall axial width of the lateral retention collar. In addition, the flange has a radial thickness that is between 5 and 100% greater than the radial thickness of the sleeve. Casting of the lateral retention collar onto the stabilizer bar can provide a push-off load of greater than 5,000 pounds.

### CROSS-REFERENCE TO RELATED APPLICATIONS

This application claims priority of U.S. Provisional Patent Application Ser. No. 60/865,511 filed Nov. 13, 2006, which is incorporated herein by reference.

### FIELD OF THE INVENTION

The present invention relates to a stabilizer bar for a motor vehicle. More particularly, the present invention relates to a stabilizer bar with a lateral retention collar cast thereon.

### BACKGROUND OF THE INVENTION

When a motor vehicle takes a turn, tile sprung mass of a vehicle body rotates around the vehicle roll axis, which passes through its center of gravity Lateral forces from the vehicle suspension at each end of the vehicle are transmitted into the sprung mass at a location known as the roll center. If the vertical distance between the roll center and the vehicle center of gravity is not zero, a torque or roll moment is exerted on the sprung mass, causing the vehicle to lean towards the outside of the turn. This force, known as the roll couple, causes a positive camber of the wheels on the outside of the turn, thereby reducing their cornering grip.

The roll couple is resisted by the suspension's roll stiffness, which is a function of the spring rate of the vehicle springs and the vehicle stabilizer bars. Increasing the roll stiffness of the suspension increases the rate of weight transfer to the wheels on the outside of the turn, thereby increasing their cornering grip. The stabilizer bar connects opposite wheels (left/right) through short lever arms linked by a torsion spring.

The stabilizer bar is typically attached to the motor vehicle chassis in order to retard lateral movement but not prevent vertical movement. The stabilizer bar utilizes a pair of bushings within retainer brackets to attach to the chassis. The bushings are typically installed on the stabilizer bar adjacent to a pair of lateral retention collars that are permanently attached to said bar. The collars can be welded, mechanically fastened or press fit onto the stabilizer bar. All of these methods of attachment can result in increased weight, labor and/or material cost to the component. Therefore, there is a need to provide an economical method for the manufacture and attachment of lateral retention collars to stabilization bars.

### SUMMARY OF THE INVENTION

A stabilizer bar with a lateral retention collar is provided. The lateral retention collar is cast onto the stabilizer bar and can be made from a zinc-aluminum alloy. In addition, the lateral retention collar is cast onto the stabilizer bar using a die casting machine. The lateral retention collar has an axial sleeve with a flange that extends radially therefrom. In some instances, the flange has a width in the axial direction, with the width being between 5 and 50% of an overall axial width of the lateral retention collar. In addition, the flange has a radial thickness that is between 5 and 100% greater than the radial thickness of the sleeve. Casting of the lateral retention collar onto the stabilizer bar can provide a push-off load of greater than 5,000 pounds.

### BRIEF DESCRIPTION OF THE FIGURES

FIG. 1 is an perspective view illustrating a stabilizer bar on a motor vehicle;

FIG. 2 is a perspective view of an embodiment of the present invention;

FIG. 3 is a side cross-sectional view of an embodiment of the present invention;

FIG. 4 is a perspective view of an embodiment of the present invention illustrating the assembly of a bushing and retainer bracket onto a stabilizer bar; and

FIG. 5 is a flowchart illustrating a method of an embodiment of the present invention.

### DETAILED DESCRIPTION OF THE PRESENT INVENTION

The present invention discloses a stabilizer bar with a lateral retention collar that is cast thereon. As such, the present invention has utility as a component of a suspension system for a motor vehicle.

The stabilizer bar with the cast lateral retention collar can be produced by placing the stabilizer bar at least partially within a die casting machine and subsequently die casting the lateral retention collar onto the stabilizer bar. In some instances, the lateral retention collar is made from a zinc-aluminum alloy. In some instances, the stabilizer bar has an outer surface that is painted before the lateral retention collar is cast thereon.

The lateral retention collar has an axial sleeve and a flange that extends radially therefrom. The flange can have a width in the axial direction, the axial width being between 5 and 50% of an overall width of the lateral retention collar. In some instances, the axial width of the flange is between 5 and 30% of thie overall width of the lateral retention collar. In addition, the flange can have a radial thickness that is between 5 and 100% greater than the radial thickness of the sleeve. The casting of the lateral retention collar onto the stabilizer bar affords for decreased cost and improved quality of the stabilizer bar plus lateral retention collar assembly. In addition, the casting of the lateral retention collar onto the stabilizer bar can provide an increase in the push-off load required to move the lateral retention collar relative to the stabilizer bar. This increase in push-off load affords for an increase in stresses that can be applied to the stabilizer bar without lateral movement of tie bar relative to a suspension or motor vehicle component, for example the chassis of a motor vehicle.

A method of manufacturing the stabilizer bar with the lateral retention collar can include providing the stabilizer bar, providing a die casting machine with molten metal available to cast the lateral retention collar, placing the stabilizer bar at least partially within the die casting machine, casting the lateral retention collar onto the stabilizer bar using the molten metal, and removing the stabilizer bar with the lateral retention collar from the die casting machine. It is appreciated that the die casting of the lateral retention collar results in a near net shape collar process that eliminates the need for welding, press fitting and the like of the lateral retention collar onto the stabilizer bar. In addition, the process disclosed herein affords for the casting of two lateral retention collars onto the stabilizer bar at the approximate same time, thereby affording for the production of the lateral retention collars simultaneously.

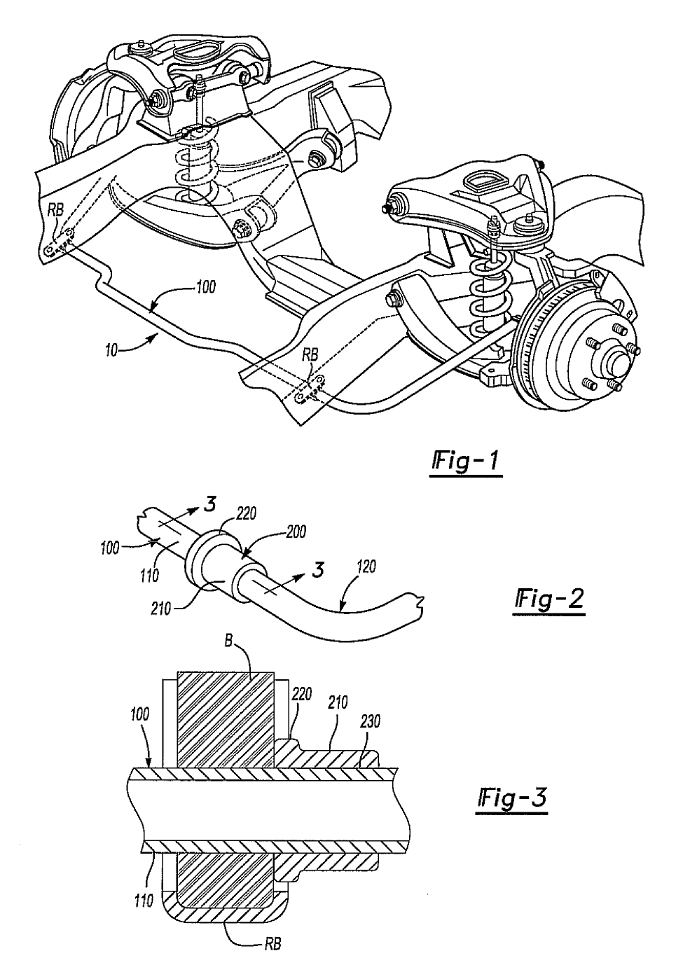

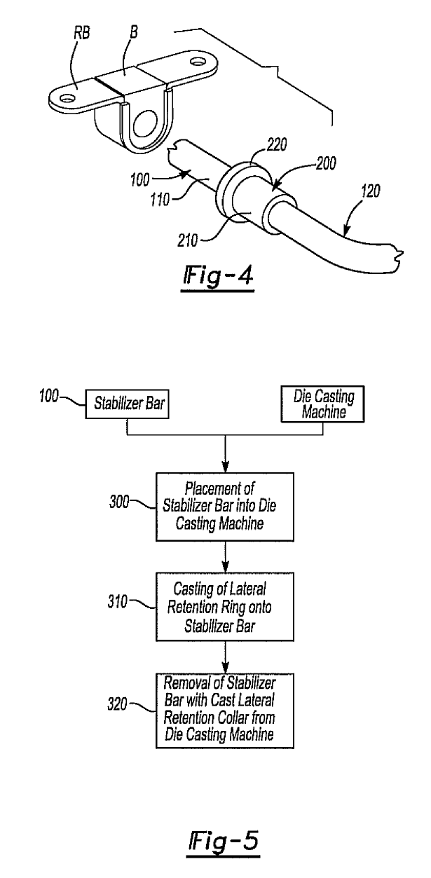

Turning now to FIG. 1, a perspective view of a stabilizer bar 100 on a motor vehicle is shown generally at reference numeral 10. In some instances, the stabilizer bar 100 is attached to the chassis of the motor vehicle using a pair of retainer brackets RB. The stabilizer bar plus lateral retention collar assembly 10 includes a stabilizer bar 100 and a lateral retention collar 200 as shown in FIG. 2. Also shown in FIG. 4 for illustrative purposes only, is a bushing B that can be placed adjacent to the retention collar 200 and the retainer bracket RB that can be placed at least partially around the bushing B and thereby afford for the attachment of the stabilizer bar 100 to a component of the motor vehicle, for example the chassis.

Turning now to FIG. 2, an enlarged perspective view of the stabilizer bar and lateral retention collar assembly 10 is provided. As shown in this figure, the stabilizer bar 100 has an outer surface 110 and can optionally include a curved portion 120. Attached to the outer surface 110 of the stabilizer bar 100 and spaced apart from the curved portion 120, is the lateral retention collar 200. The lateral retention collar can include a sleeve 210 and a flange 220 extending from the sleeve 210.

The lateral retention collar 200 is permanently attached to the stabilizer bar 100 by initially placing the bar 100 within a die casting machine (not shown) with an appropriate mold(s) or die(s) held within the die casting machine. After the stabilizer bar 100 is placed within the die casting machine, the collar 200 is formed by the injection of a molten metal or alloy into a collar cavity (not shown) at high pressure. In some instances the molten metal is aluminum and the molten alloy is an aluminum alloy. In other instances, the molten alloy is a zinc-aluminum alloy. After the molten metal or alloy is injected into the collar cavity about the stabilizer bar 100, the molten metal or alloy solidifies and forms the collar 200. In this manner the collar 200 is cast onto the stabilizer bar 100.

Upon casting of the collar 200, an inner surface 230 as shown in FIG. 3 is created. The inner surface 230 comes into contact with the outer surface 110 of the stabilizer bar 100, with the inner surface 230 and the outer surface 110 affording the permanent attachment of the collar 200 onto the stabilizer bar 100. Not being bound by theory, the inventor postulates that the permanent attachment is afforded by a metallurgical bond between the inner surface 230 of the collar 200 and tie outer surface 110 of the stabilizer bar, the contraction of the collar 200 onto the stabilizer bar 100 during solidification and/or cooling of the collar 200 after being cast, and combinations thereof.

Referring to FIG. 3, the lateral retention collar 200 with the flange 220 extending from the sleeve 210 has a geometry that is suitable for the die casting process and affords for firmly securing a bushing B onto the stabilizer bar 100. The cross-sectional radial thickness of the flange 220 can range from 1 to 50 millimeters (mm), and in some instances has a radial thickness of between 5 and 25 mm, inclusive. The cross-sectional radial thickness of the sleeve 210 can range from 1 to 25 mm, and in some instances has a thickness of between 2 and 10 mm. The axial width of the lateral retention collar 200 can be between 5 and 100 mm. In some instances, the overall width of the collar 200 is between 5 and 50 mm, and in still other instances, can be between 7 and 30 mm. The axial width of the flange 220 can be between 1 and 95% of the overall width of the collar 200. In some instances, the width of the flange 220 is between 5 and 75% of the overall width of the collar 200 and in some instances is between 5 and 50%. In still yet other instances, the axial width of the flange 220 is between 5 and 30% of the overall width of the collar 200. It is appreciated that the width and thicknesses provided above are in fact dependent on the size of the stabilizer bar onto which the lateral retention collar 200 is to be cast thereon and can be larger or smaller than disclosed above.

A stabilizer bar 100 with a cast lateral retention collar 200 can experience push-off loads (force required to move the collar on the stabilizer bar) of more than 5,000 pounds. Furthermore, production of the lateral retention collars 200 can be produced on stabilizer bars 100 over and/or under painted surfaces and more than one collar 200 can be cast at a given time.

Turning now to FIG. 5, a schematic flow diagram of a method of manufacture for the stabilizer bar and lateral retention collar assembly is provided. As shown in this figure, a stabilizer bar 100 can be provided along with a die casting machine. The stabilizer bar is placed at least partially within die casting machine at step 300. Thereafter, the lateral retention collar is cast onto the stabilizer bar at step 310 by forcing molten metal into a lateral retention collar cavity that is about the stabilizer bar. After the lateral retention collar has been cast onto die stabilizer bar, die stabilizer bar and cast lateral retention collar assembly is removed from the die casting machine at step 320. In this manner, a lateral retention collar is provided for a stabilizer bar using the die casting process.

The foregoing discussion discloses and describes several embodiments of the present invention. One skilled in the art will readily recognize from such discussion, and from the accompanying drawings and claims, that various changes, modifications and the like can be made without departing from the true spirit and fair scope of the invention as defined in the following claims.

I claim:

1. A stabilizer bar and lateral retention collar assembly comprising:
a stabilizer bar;
a cast lateral retention collar on said stabilizer bar.

2. The assembly of claim 1, wherein said cast lateral retention collar is cast onto said stabilizer bar.

3. The assembly of claim 2, wherein said cast lateral retention collar is cast onto said stabilizer bar using a die casting machine.

4. The assembly of claim 2, wherein said cast retention collar is made from a zinc-aluminum alloy.

5. The assembly of claim 2, wherein said stabilizer bar has all outer surface that is painted, said cast lateral retention collar cast onto said painted outer surface of said stabilizer bar.

6. The assembly of claim 2, wherein said cast lateral retention collar has a sleeve with a flange extending radial therefrom.

7. The assembly of claim 6, wherein said flange has a width in an axial direction, said axial width between 5 and 50% of an overall width of said lateral retention collar.

8. The assembly of claim 7, wherein said flange has a width in an axial direction, said axial width between 5 and 30% of an overall width of said lateral retention collar.

9. The assembly of claim 6, wherein said flange has a radial thickness between 5 and 100% greater than a radial thickness of said sleeve.

10. A stabilizer bar and lateral retention collar assembly comprising:
a stabilizer bar;
a cast lateral retention collar on said stabilizer bar, said cast lateral retention collar cast onto said stabilizer bar by die casting.

11. The assembly of claim 10, wherein said cast retention collar is made from a zinc-aluminum alloy.

12. A process for making a stabilizer bar with a lateral retention collar, the process comprising:
providing a stabilizer bar;
providing a die casting machine with molten metal;
placing The stabilizer bar at least partially within the die casting machine;
casting a lateral retention collar onto the stabilizer bar using the molten metal; and
removing the stabilizer bar with the lateral retention collar from the die casting machine.

13. The process of claim of claim 12, wherein the stabilizer bar is painted before being placed at least partially within the die casting machine.

14. The process of claim 12, further including a die having a cavity dimensioned to accept die stabilizer bar.

15. The process of claim 14, wherein the cavity is dimensioned to accept the molten metal and form the lateral retention collar.

16. The process of claim 14, wherein tie cavity is dimensioned to accept the molten metal and form two lateral retention collars on the stabilizer bar.

17. The process of claim 16, wherein the two lateral retention collars are cast onto the stabilizer bar at generally the same time.

18. The process of claim 15, wherein the cavity is dimensioned to accept the molten metal and form the lateral retention collar with a sleeve with a flange extending radial therefrom.

19. The process of claim 18, wherein the flange has a width in an axial direction, tie axial width being between 5 and 50% of an overall width of the lateral retention collar.

20. The process of claim 19, wherein the flange has a radial thickness being between 5 and 100% greater than a radial thickness of the sleeve.
